(19) United States
(12) Patent Application Publication
(10) Pub. No.: US 2004/0238034 A1
(43) Pub. Date: Dec. 2, 2004

(54) Stopper valve structure for fuel tank

(75) Inventors: Keiji Suzuki, Sashima-gun (JP); Tadashi Shimamori, Shinjuku-ku (JP); Yoshiaki Oyamada, Shinjuku-ku (JP); Katsuyuki Ichinohe, Shinjuku-ku (JP)

Correspondence Address: OLIFF & BERRIDGE, PLC, P.O. BOX 19928, ALEXANDRIA, VA, 22320, US

(73) Assignees: KYOSAN DENKI CO., LTD., Sashima-gun (JP); FUJI JUKOGYO KABUSHIKI KAISHA, Shinjuku-ku (JP)

(21) Appl. No.: 10/852,242

(22) Filed: May 25, 2004

(30) Foreign Application Priority Data
May 28, 2003 (JP) 2003-150559

(51) Int. Cl. F16K 24/04

(52) U.S. Cl. 137/202

(57) ABSTRACT

A stopper valve for a fuel tank is provided which includes a valve housing, float movable upward/downward within the housing, valve element disposed on the top of the float, space formed downstream of the valve element and open via a through hole, and air inlet/outlet port provided downstream of the space and leading to a canister. One end portion of the air inlet/outlet port is located within the space and an opening is formed in the same end portion so as to be eccentric to the through hole and face upward.

The disclosure of Japanese Patent Application No. 2003-150559 filed on May 28, 2003 including the specification, drawings and abstract is incorporated herein by reference in its entirety.

### BACKGROUND OF THE INVENTION

1. Field of the Invention

The invention relates to the structure of a stopper valve provided at an air inlet/outlet port of a fuel tank connected to a canister, and more specifically, it relates to the structure of such a stopper valve configured to minimize or hopefully eliminate the chances that the fuel spilled or brought out from the fuel tank would reach the canister.

2. Description of the Related Art

As is widely known, a fuel tank of a vehicle or the like is connected to an air inlet/outlet passage (port) through which air flows into or out of the fuel tank as fuel is drawn out of or into it. Along such an air inlet/outlet passage is sometime provided a canister which absorbs fuel vapors coming from the fuel tank. If fuel is fed to the fuel tank beyond the limit fuel level and outflows to the canister, the canister gets wet by such fuel and may be damaged. To prevent this, therefore, a known art provides a stopper valve in the upper portion of the fuel tank, which closes and shuts off the fuel tank from the air inlet/outlet passage in response to the fuel tank being filled up to the limit level.

FIG. 7 is a view schematically showing the configuration of one exemplary stopper valve A for the above use. The stopper valve A includes a housing b, a float c disposed in the housing b, a spring d urging the float c upward, a valve element e fixed on the top of the float c, an air inlet/outlet port f that opens at one end to the downstream side of the valve e. Meanwhile, the other end of the port f is not shown in the drawing.

The housing b is an annular case having openings in the upper and lower sides. A float chamber g is formed within the housing b. Above the float chamber g is formed a valve seat q, and below is provided a bottom plate j having a plurality of through holes i.

When the fuel level has reached the bottom plate j during the feeding of fuel into the fuel tank a, the fuel then starts entering the housing b via the through holes i. After the fuel has exceeded a certain level within the housing b, it then lifts up the float c until the valve element e abuts against the valve seat q and thereby shuts off the air inlet/outlet port f from the fuel tank a. At this time, the pressure in the stopper valve A starts increasing and the feeding of fuel will automatically stop at the fuel level H in a while. This is how the stopper valve A works to prevent the outflow of fuel to the canister.

However, the foregoing structure of the stopper valve A involves the possibility that the valve element e is momentarily unseated from the valve seat q and some fuel spills out from the fuel tank a towards the canister through the air inlet/outlet port f if the fuel sloshes around in the fuel tank a during the vehicle turning or stopping quickly.

Also, even before the stopper valve A closes during the feeding of fuel, some fuel in liquid state may ride on the airflow and reach the canister before separated from the air. Even in a case where the fuel is only brought to the interior of the air inlet/outlet port f, not the canister, there still remains the possibility of such fuel reaching the canister if its amount increases.

To eliminate or minimize such problems, another known art (see Japanese Laid-opened Patent Application No 2002-235863) proposes a different stopper valve structure as shown in FIG. 6. This valve has an upper housing portion m in which a space k is provided interposed between the housing b and one end portion of the air inlet/outlet port f that is located right above a through hole n. In that end portion is formed an opening p facing upward and overlapping the through hole n as viewed from above.

In this art, even if some fuel has ridden on the airflow and entered the space k through the through hole n, the fuel hits against the bottom of the air inlet/outlet port f and is thereby separated from the air. Moreover, the air thus separated from the fuel has to go all the way along the air inlet/outlet port f before reaching the opening p. This structure, therefore, reduces the amount of fuel that reaches the canister.

In the above art, however, to separate the air and fuel, the end portion of the air inlet/outlet port f has to be right above the through hole n and sufficient clearance (clearance h) is needed between the bottom of the air inlet/outlet port f and the bottom of the upper housing m (or the top of the fuel tank a). Having such a clearance, however, would surely increase the height (i.e., size) and weight of the stopper valve A. Also, it is not desirable that a large portion of the stopper valve A protrudes out from the top of the fuel tank a in terms of the freedom or flexibility in using the stopper valve in various vehicles or the like. Moreover, in the above case, since the area of the surface of the stopper valve A that is exposed to the ambient air becomes relatively large, the amount of HC which permeates the fuel tank a will increase.

Additionally, because the opening p is above the through hole n, the fuel which has flowed fast into the space k via the through hole n may easily reach the upper region of the space k and enter the air inlet/outlet port f despite that the opening p faces upward. Consequently, the stopper valve shown in FIG. 6 still leaves room for improvement in the reliability in preventing fuel from reaching the canister through the air inlet/outlet port.

### SUMMARY OF THE INVENTION

In view of the above situation, the invention proposes a stopper valve structure which prevents fuel from reaching the canister when the valve momentarily opens during the fuel tank being full, while reducing the size and weight of the valve unit and thus broadening its use among various vehicles and the like.

To achieve this object, a first aspect of the invention relates to a stopper valve structure for a fuel tank, including (i) a valve housing in which a first space is provided downstream of the fuel tank and a second space is provided downstream of the first space, the first space and the second space opening to each other via a through hole formed in a wall separating the first and second spaces; (ii) a float movable upward/downward in the first space; and (iii) an air inlet/outlet port provided downstream of the second space of the valve housing, one end portion of the air inlet/outlet port being located within the second space and having an opening facing upward and eccentric with respect to the through hole.

According to this stopper valve structure, forming the opening eccentric with respect to the through hole and face upward eliminates the necessity to extend the air inlet/outlet port to the point right above the through hole, and the same port may also be located as low as its bottom is substantially at the same height as the lower end of the second space. Therefore, the height (i.e., size) of the valve housing may be reduced accordingly. Also, the opening of the air inlet/outlet port and the through hole are distant from each other, and the path connecting those two elements may be made roundabout. Therefore, if the valve has momentarily opened during the fuel tank being full and some fuel has spilled out, such fuel will not reach the canister via the opening of the air inlet/outlet port. Also, even if fuel vapor form some fuel drops and they trickle down along the inner wall, it is very unlikely that such fuel (liquid fuel) would enter the opening 23 and reach the canister.

### BRIEF DESCRIPTION OF THE DRAWINGS

The foregoing and/or further objects, features and advantages of the invention will become more apparent from the following description of preferred exemplary embodiments with reference to the accompanying drawings, in which like numerals are used to represent like elements and wherein:

FIG. 1 is a sectional view schematically showing a stopper valve according to a first exemplary embodiment of the invention which is mounted on a fuel tank;

FIG. 2 is a top view of the stopper valve uncapped;

FIG. 3 is another top view of the same valve;

FIG. 4 is a sectional view schematically showing a stopper valve according to a second exemplary embodiment of the invention;

FIG. 5 is a sectional view schematically showing a stopper valve according to a third exemplary embodiment of the invention;

FIG. 6 is a sectional view schematically showing a related-art stopper valve for a fuel tank; and

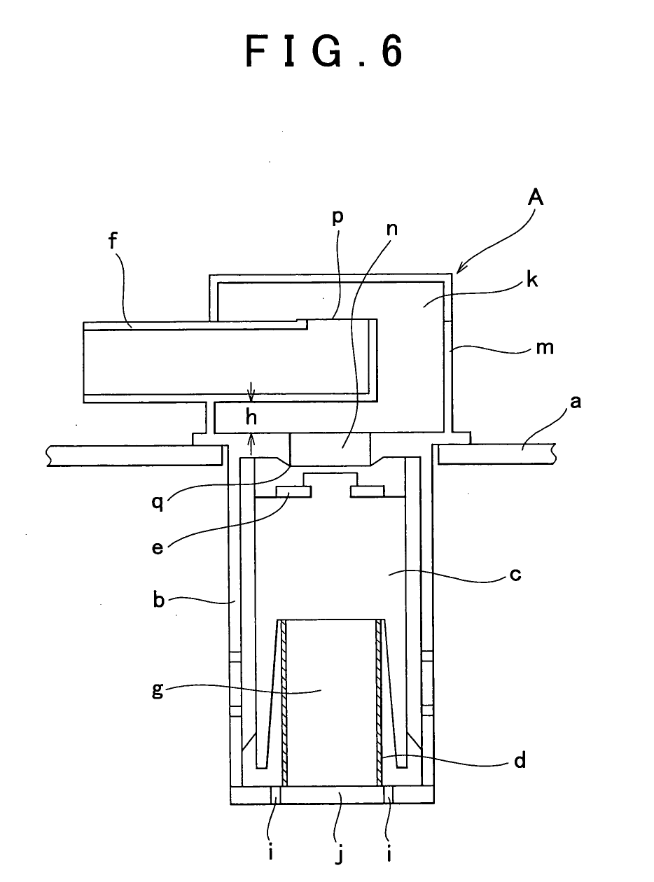

FIG. 7 is a sectional view schematically showing another related-art stopper valve for a fuel tank.

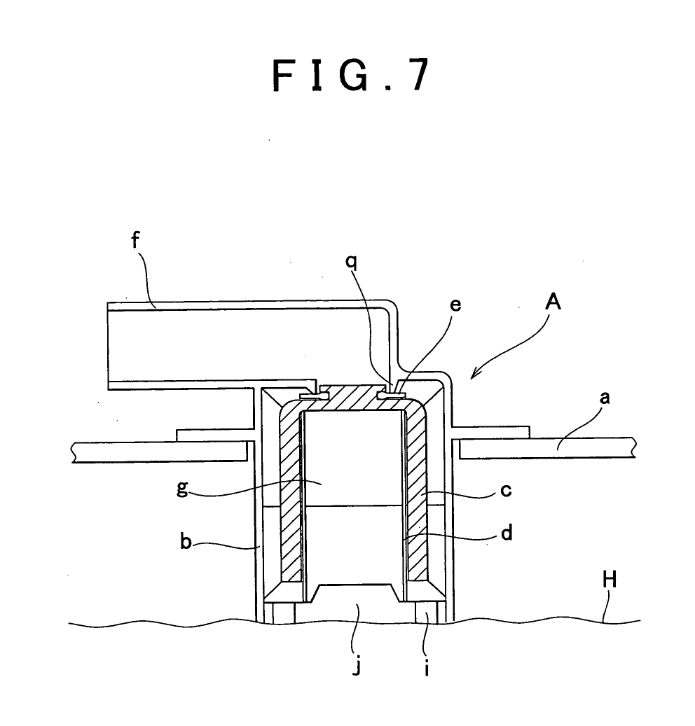

### DETAILED DESCRIPTION OF THE PREFERRED EXEMPLARY EMBODIMENTS

(First Exemplary Embodiment)

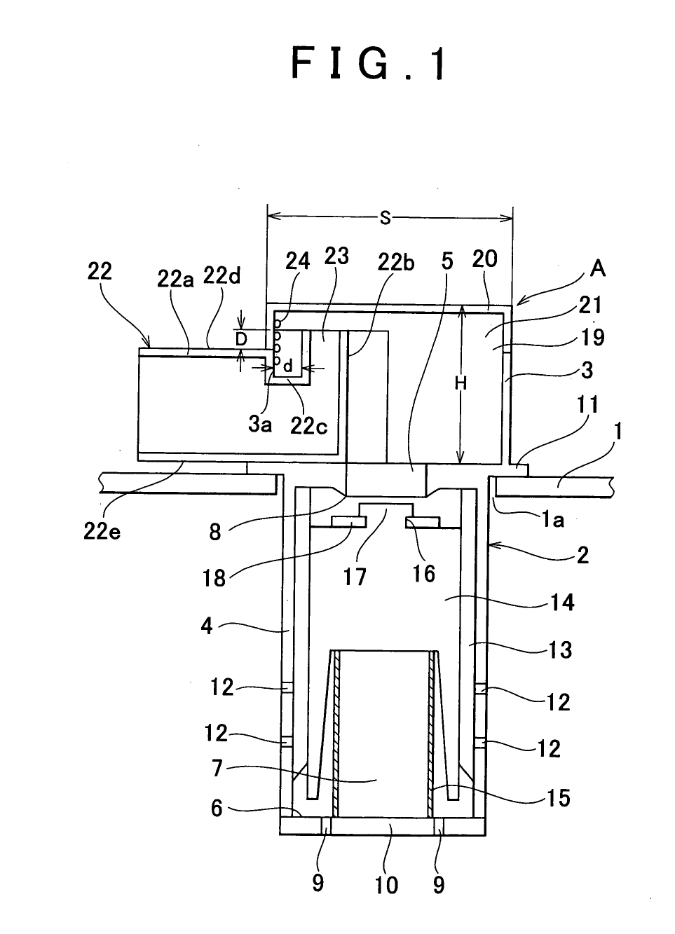

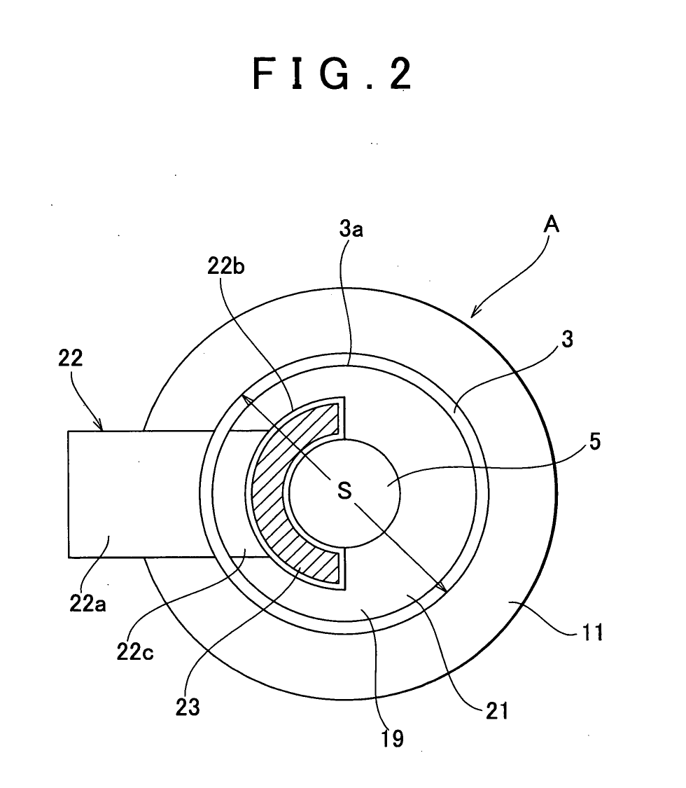

FIG. 1 is a sectional view schematically showing a stopper valve according to a first exemplary embodiment of the invention which is mounted on a fuel tank, and FIG. 2 is a top view of the same valve uncapped.

Referring to FIG. 1, the stopper valve A is mounted on the fuel tank 1. The fuel tank 1 is made of resin and has a tank opening 1a in the upper wall, and the stopper valve A, when installed, is fixed onto the top of the fuel tank 1 by heat welding, or the like, while the lower portion of the valve A is inserted into the fuel tank 1 through the tank opening 1a. Alternatively, the fuel tank 1 may be a metal tank. In this case, the stopper valve A may be fixed to the fuel tank using screws, etc.

A housing 2 of the stopper valve A is made of resin and includes an upper housing portion 3 and a lower housing portion 4.

A float chamber 7 is formed within the lower housing portion 4, and a through hole 5 is provided in the upper side of the float chamber 7 and a lower opening 6 of a diameter larger than the through hole 5 is formed in the lower side. Thus, the float chamber 7 and the interior of the upper housing portion 3 open to each other via the through hole 5. The periphery of the through hole 5 protrudes downward thus forming a valve seat 8. Meanwhile, a bottom plate 10 having a plurality of bottom holes 9 is fixed to the lower end of the lower housing portion 4 by head welding, or the like, so as to cover the lower opening 6.

A flange 11 is formed at the circumference of the wall between the upper housing portion 3 and the lower housing portion 4. When installing the stopper valve A to the fuel tank 1, the flange 11 is fixed onto the periphery of the fuel tank opening 1a while the lower housing portion 4 of the stopper valve A is inserted into the fuel tank 1.

A plurality of side holes 12 are formed in the sidewall of the lower housing portion 4. Vertical ribs 13 are formed on the inner surface of the float chamber 7 at equal intervals from one another to guide a float 14 to move upward/downward in the float chamber 7.

The float 14 is a cylindrical float hollowed in the bottom side. A spring 15 is disposed between the float 14 and the bottom plate 10 such that it acts on the float 14. The spring force of the spring 15 is not strong enough to lift up the float 14 on its own, therefore it just helps the float 14 move upward fast as the fuel level rises in the float chamber 7.

A protrusion 17 is provided on the top of the float 14. At the circumference of the protrusion 17 is formed a groove 16 to which a ring-shaped valve element 18 made of rubber is fit. When the float 14 has moved up to the upper end of the float chamber 7, the valve element 18 abuts against the valve seat 8 and thus shuts off the communication between the float chamber 7 and the interior of the upper housing portion 3. The valve element 18 remains in tight contact with the valve seat 8 even when fit thereto unevenly. That is, the valve element 18 is able to seal between the float chamber 7 and the interior of the upper housing portion 3 even when fit to the valve seat 8 with the float 14 inclined. This is how the float 14, spring 15, valve element 18, etc., are arranged within the float chamber 7 to stop the feeding of fuel in response to the fuel level reaching the limit level.

In the meantime, the upper housing portion 3 is a cylindrical case having a diameter S as viewed from above, in which a space 21 is defined. The upper housing portion 3 and the lower housing portion 4 are integrally formed. In the upper housing portion 3, the through hole 5 is located in the lower side of the space 21, and this hole, as mentioned above, places the space 21 (i.e., the interior of the upper housing portion 3) and the float chamber 7 (i.e., the interior of the lower housing portion 4) in communication. An upper opening 19 is formed in the upper side of the space 21, and a cap 20 is fixed on the top of the upper housing portion 3 by heat welding or the like so as to cover the upper opening 19.

An air inlet/outlet port 22 is provided in one side of the upper housing portion 3 and one end portion of the same port 22 is located within the space 21 of the upper housing portion 3. In this exemplary embodiment, the air inlet/outlet port 22 and the lower housing portion (i.e., the housing 2) are also integrally formed. The air inlet/outlet port 22 is located such that a bottom surface 22e, which is substantially at the same height as the lower end of the side wall of the upper housing portion 3, is in contact with the top surface of the flange 11. Such location of the air inlet/outlet port 22 reduces height H in FIG. 1 which indicates the length by which the stopper valve A protrudes upward from the fuel tank 1.

The air inlet/outlet port 22, in one side (i.e., the left side of the air inlet/outlet port 22 in FIG. 1), leads to a canister via a passage, both not shown. In the other side of the air inlet/outlet port 22 is formed an opening 23 facing upward at the upper end of a vertical wall 22b. Thus, the air inlet/outlet port 22 and the space 21 are open to each other through the opening 23. Also, a concave portion 22c is formed between a horizontal wall 22a and the vertical wall 22b of the air inlet/outlet port 22.

The width of the concave portion 22c is such that a gap of length d is formed between an internal wall 3a and the wall opposite thereto. This length d indicates the distance at which the opening 23 is located away from the internal wall 3a towards the other side of the upper housing portion 3. With this arrangement, fuel drops 24 (i.e., fuel in liquid state) trickle down along the internal wall 3a, but do not enter the opening 23.

The upper end of the opening 23 is located at height D above the air inlet/outlet port 22. This makes it more difficult for the fuel drops 24 to enter the opening 23. That is, they just fall along the internal wall 3a and the concave portion 22c.

FIG. 2 is a top view of the stopper valve A when the cap 20 has been removed. Referring to this drawing, the opening 23 is formed semicircular along the circumference of the through hole 5. Thus shaped and located in the space 21, the opening 23 has a relatively large area which reduces the airflow resistance without the diameter S of the upper housing portion 3 being increased. Also, the opening 23 is not located right above the through hole 5, and this contributes to lowering the airflow resistance even more.

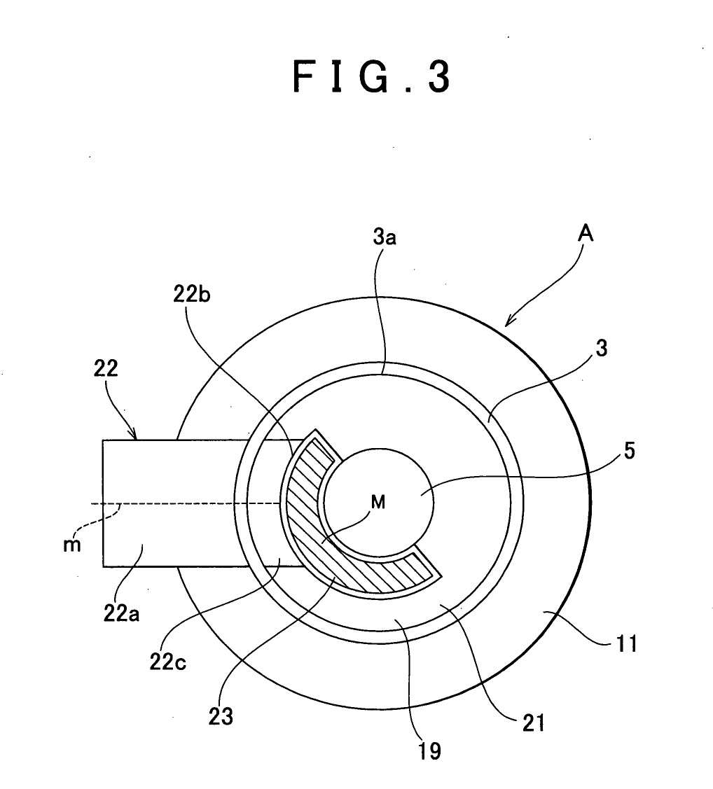

By the way, the opening 23 may alternatively be formed in an arc like shape, a crescent-like shape, an elongated shape, a round shape, a polygonal shape, and so on. Also, referring to FIG. 3, the opening 23 may be formed such that, as compared to the above-mentioned case, the center M of the opening 23 has been displaced from the axial center m of the air inlet/outlet port 22 along the circumference of the opening 23. Also, the air inlet/outlet port 22 and the upper housing portion 3 shall not necessarily be formed integrally.

Hereinafter, the operation of the stopper valve A will be described. Once the feeding of fuel into the fuel tank 1 has stared, the internal pressure of the fuel tank 1 increases so that the air flows into the space 21 via the float chamber 7. The air passes through the space 21 and the air inlet/outlet port 22 and reaches the canister to which fuel vapors are absorbed. During the feeding of fuel, the fuel level rises within the fuel tank 1 while the air is being discharged therefrom at a corresponding flow rate. In response to the fuel level reaching a certain level afterwards, the fuel starts entering the float chamber 7 via the bottom holes 9 and the side holes 12, and then lifting up the float chamber 7 in cooperation with the spring 15. At the time the float 14 reaches the upper end, the valve element 18 abuts against the valve seat 8 thus stopping the discharging of the air. After this, the pressure within the fuel tank 1 will keep increasing and the feeding of fuel will therefore stop automatically in a while.

With the opening 23 made eccentric to the through hole 5 and face upward as above, if the valve element 18 has been momentarily unseated from the valve seat 8 due to the vehicle turning or stopping quickly during the fuel tank 1 being full and some fuel therefore has spilled out from the fuel tank 1, the fuel will not enter the air inlet/outlet port 22. Such shape and location of the opening 23, more importantly, achieves said advantage without the upper housing portion 3 being enlarged.

Furthermore, during the feeding of fuel into the fuel tank 1 where the stopper valve A is still open, some fuel may ride on the air flowing into the space 21 and that fuel may form some fuel drops on the inner wall of the space 21. According to the above structure, however, those fuel drops will return into the fuel tank 1 through the float chamber 7, thus they will not enter air inlet/outlet port 22 via the opening 23.

(Second Exemplary Embodiment)

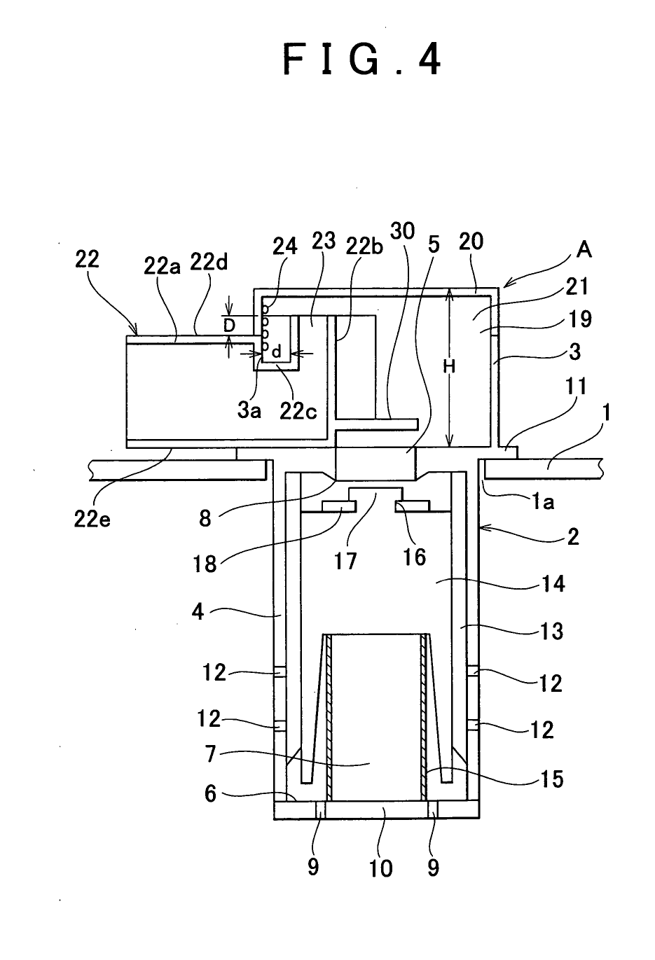

FIG. 4 is a sectional view schematically showing a stopper valve according to a second exemplary embodiment of the invention. This valve is only different from the first exemplary embodiment valve in that a separation wall 30 is provided above the through hole 5, and therefore like numerals and characters will be used for like elements of the structure.

As in the first exemplary embodiment, the housing 2 of the stopper valve A is made of resin and includes the upper housing portion 3 and lower housing portion 4. The structure within the lower housing portion 4 is the same as described in the first exemplary embodiment, therefore it will not be explained again.

The upper housing portion 3 is integrally formed with the lower housing portion 4, and the through hole 5 is formed in the lower side of the space 21 while the upper opening 19 is formed in the upper side. The cap 20 made of resin is fixed on the top of the upper housing portion 3 by heat welding or the like so as to cover the upper opening 19.

The air inlet/outlet port 22 is provided in one side of the upper housing portion 3 and the end portion of the same port 22 is located within the space 21. The air inlet/outlet port 22 is located such that the bottom surface 22e, which is substantially at the same height as the lower end of the side wall of the upper housing portion 3, is in contact with the top surface of the flange 11. Such location of the air inlet/outlet port 22 reduces the height H as aforementioned.

The air inlet/outlet port 22, in one side (i.e., the left side of the air inlet/outlet port 22 in FIG. 1), leads to the canister. In the other side of the air inlet/outlet port 22 is formed the opening 23 facing upward at the upper end of the vertical wall 22b. Thus, the air inlet/outlet port 22 and the space 21 are open to each other through the opening 23. Also, the concave portion 22c is formed between the horizontal wall 22a and the vertical wall 22b of the air inlet/outlet port 22.

The width of the concave portion 22c is such that a gap of length d is formed between the internal wall 3a and the wall opposite thereto. This length d corresponds to the distance at which the opening 23 is located away from the internal wall 3a towards the other side of the upper housing portion 3. With this arrangement, fuel drops 24 (i.e., fuel in liquid state) trickle down along the internal wall 3a, but will not enter the opening 23.

The upper end of the opening 23 is located at height D above the air inlet/outlet port 22. This makes it more difficult for the fuel drops 24 to enter the opening 23. That is, they just fall along the internal wall 3a and the concave portion 22c.

In this exemplary embodiment, a separation wall 30 is provided at the periphery of the vertical wall 22b. This separation wall 30 has generally a round shape as viewed from above and horizontally sticks out from the vertical wall 22b at a predetermined height above the through hole 5. Also, the separation wall 30 is sized almost equal to the through hole 5, and is located so as to overlap the thorough hole 5.

Thus shaped and located, the separation wall 30 blocks liquid fuel (i.e., fuel drops) moving on the airflow towards the canister. That is, such fuel drops are separated from the air by hitting against the separation wall 30 and brought back into the fuel tank 1. Furthermore, for example, if the valve element 18 has been momentarily unseated from the valve seat 8 due to the vehicle turning or stopping quickly with the fuel tank 1 being full and some fuel therefore has spilled out into the space 21, the fuel will hit against the separation wall 30 and return into the fuel tank 1.

The separation wall 30, as already mentioned, is integrally formed at the periphery of the air inlet/outlet port 22 and horizontally sticks out from the vertical wall 22b. Such location of the separation wall 30 leaves a sufficient space for the air to flow between the through hole 5 and the space 21 even if the air inlet/outlet port 22 is located as low as the bottom surface 22e of the air inlet/outlet port 22, which is substantially at the same height as the lower end of the side wall of the upper housing portion 3, abuts on the top surface of the flange 11. Therefore, the height H can be reduced.

(Third Exemplary Embodiment)

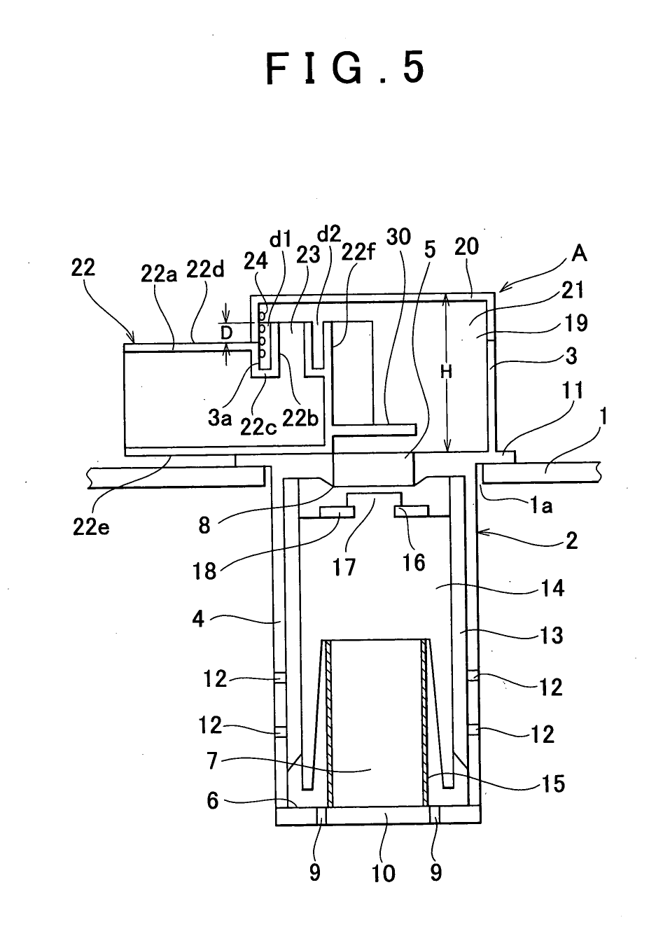

FIG. 5 is a sectional view schematically showing a stopper valve according to a third exemplary embodiment of the invention. This valve is one modification example of the second exemplary embodiment valve where gaps d1, d2 are provided in both sides of the opening 23. As in the second exemplary embodiment, like numerals and characters will be used for like elements of the structure.

The housing 2 of the stopper valve A is made of resin and includes the upper housing portion 3 and lower housing portion 4. The structure within the lower housing portion 4 is the same as described in the first exemplary embodiment, therefore its explanation will not be made again.

The upper housing portion 3 is integrally formed with the lower housing portion 4, and the through hole 5 is formed in the lower side of the space 21 while the upper opening 19 is formed in the upper side. The resin cap 20 is fixed on the top of the upper housing portion 3 by heat welding or the like so as to cover the upper opening 19.

The air inlet/outlet port 22 is provided in one side of the upper housing portion 3 and the end portion of the same port 22 is located within the space 21. The air inlet/outlet port 22 is located such that the bottom surface 22e, which is substantially at the same height as the lower end of the side wall of the upper housing portion 3, abuts on the top surface of the flange 11. Such location of the air inlet/outlet port 22 reduces height H.

The air inlet/outlet port 22, in one side (i.e., the left side of the air inlet/outlet port 22 in FIG. 1), leads to the canister. In the other side of the air inlet/outlet port 22 is formed the opening 23 facing upward at the upper end of the vertical wall 22b. Thus, the air inlet/outlet port 22 and the space 21 are open to each other through the opening 23. Also, the concave portion 22c is formed between the horizontal wall 22a and the vertical wall 22b of the air inlet/outlet port 22.

In the third exemplary embodiment, the opening 23 is formed at a distance equal to the width of the gap d1 from the internal wall 3a of the upper housing portion 3 and a vertical wall 22f is formed at a distance equal to the width of the gap d2 from the other side of the opening 23.

This structure makes it more difficult for the fuel drops 24 to enter the opening 23. That is, they just trickle down along the internal wall 3a of the upper housing portion 3. Moreover, even if some fuel has entered the space 21 on the airflow flowing thereinto, the amount of the fuel that will reach the opening 23 beyond the vertical wall 22f and the gap d2 will be very small.

The upper end of the opening 23 is located at height D above the air inlet/outlet port 22, which makes it more difficult for the fuel drops 24 to enter the opening 23. That is, they just fall along the internal wall 3a and the concave portion 22c.

In this exemplary embodiment, too, the separation wall 30 is provided at the periphery of the vertical wall 22b. This separation wall 30 has generally a round shape as viewed from above and horizontally sticks out from the vertical wall 22b at a predetermined height above the through hole 5. Also, the separation wall 30 is sized almost equal to the through hole 5, and overlaps the thorough hole 5.

Thus shaped and located, the separation wall 30 blocks liquid fuel (i.e., fuel drops) moving on the airflow towards the canister. That is, such fuel drops are separated from the air by hitting against the separation wall 30 and brought back into the fuel tank 1. Furthermore, for example, if the valve element 18 has been momentarily unseated from the valve seat 8 due to the vehicle turning or stopping quickly with the fuel tank 1 being full and some fuel therefore has spilled out into the space 21, the fuel will hit against the separation wall 30 and return into the fuel tank 1.

The separation wall 30, as already mentioned, is integrally formed at the periphery of the air inlet/outlet port 22 and horizontally sticks out from the vertical wall 22b. Such location of the separation wall 30 leaves a sufficient space for the air to flow between the through hole 5 and the space 21 even if the air inlet/outlet port 22 is located as low as the bottom surface 22e of the air inlet/outlet port 22, which is substantially at the same height as the lower end of the side wall of the upper housing portion 3, abuts on the top surface of the flange 11. Therefore, the height H can be reduced.

According to the exemplary embodiments of the invention, because the opening 23 is eccentric to the through hole 5 and faces upward, the air inlet/outlet port 22 need not be extended to the point right above the through hole 5, and the same port 22 may be located as low as its bottom is at the same height as the bottom of the upper housing portion 3. So the size, weight, and cost of the whole valve unit are reduced and its use is therefore broadened among various vehicles or the like. Also, the amount of fuel which permeates the fuel tank reduces.

Furthermore, there is a relatively large distance between the opening 23 of the air inlet/outlet port 22 and the valve seat 8, which further reduces the likelihood that the fuel spilled out from the fuel tank 1 due to the stopper valve A being momentarily unseated would reach the canister through the opening 23. Also, the fuel drops transformed from fuel vapors will not enter the opening 23 and reach the canister, but they just trickle down along the internal wall. As a result, the lifetime of the canister will be prolonged, and the size and weight of the canister may be reduced accordingly.

Also, the upper end of the opening 23 is located higher than the upper end of the air inlet/outlet port 23, which increases the distance between the valve seat 8 and the opening 23 even more. This structure further reduces the likelihood that the spilled fuel or fuel drops transformed from furl vapor would reach the canister through the opening 23. As a result, the lifetime of the canister will be even longer, and the size and weight of the canister may be reduced accordingly.

Also, the opening 23 is located at a predetermined distance from the internal wall of the upper housing portion 3 defining one side of the space 21, which further improves the reliability in preventing the spilled fuel or fuel drops transformed from fuel vapor from reaching the canister through the opening 23.

The opening 23 may be formed in an elongated shape or an arc-like shape. In this case, the sectional area of the opening 23 increases and the airflow resistance decreases accordingly. Therefore, the size of the upper housing portion 3 can be made still smaller and the cost of the valve unit can be reduced accordingly.

According to the second and third exemplary embodiments, the separation wall 30 blocks fuel entering on the airflow towards the canister during the feeding of fuel into the fuel tank 1. That is, such fuel hits against the separation wall and is thereby separated from the air and the separated fuel then returns into the fuel tank 1. As a result, it further improves the reliability in preventing fuel from reaching the canister.

While the invention has been described with reference to preferred exemplary embodiments thereof, it is to be understood that the invention is not limited to the preferred exemplary embodiments or constructions. To the contrary, the invention is intended to cover various modifications and equivalent arrangements. In addition, while the various elements of the preferred exemplary embodiments are shown in various combinations and configurations, which are exemplary, other combinations and configurations, including more, less or only a single element, are also within the spirit and scope of the invention.

What is claimed is:

1. A stopper valve structure for a fuel tank, comprising:
a valve housing in which a first space is provided downstream of the fuel tank and a second space is provided downstream of the first space, the first space and the second space opening to each other via a through hole formed in a wall separating the first and second spaces;
a float movable upward/downward in the first space; and
an air inlet/outlet port provided downstream of the second space of the valve housing, one end portion of the air inlet/outlet port being located within the second space and having an opening facing upward and eccentric with respect to the through hole.

2. A stopper valve structure according to claim 1, wherein the opening is located higher than the upper end of the air inlet/outlet port.

3. A stopper valve structure according to claim 1, wherein the bottom surface of the air inlet/outlet port is at substantially the same height as the lower end of the second space.

4. A stopper valve structure according to claim 1, wherein the opening is located at a predetermined distance from one inner wall of the valve housing which defines one side of the second space.

5. A stopper valve structure according to claim 1, wherein the opening has an elongated shape in section.

6. A stopper valve structure according to claim 1, wherein the opening has an arc-like shape in section.

7. A stopper valve structure according to claim 1, further comprising a separation wall separating liquid and air in the second space.

8. A stopper valve structure according to claim 7, wherein the separation wall overlaps the through hole.

9. A stopper valve structure according to claim 7, wherein the separation wall has generally a round shape as viewed from above.
